(19) United States
(12) Patent Application Publication
(10) Pub. No.: US 2021/0215361 A1
(43) Pub. Date: Jul. 15, 2021

(54) Fume Extraction Device

(71) Applicant: Waldner Laboreinrichtungen GmbH & Co. KG, Vangen im Allgau (DE)

(72) Inventor: Jurgen Liebsch, Scheidegg im Allgau (DE)

(21) Appl. No.: 16/092,330

(22) PCT Filed: Apr. 18, 2017
(86) PCT No.: PCT/EP2017/059152

§ 371 Date: Oct. 9, 2018

(30) Foreign Application Priority Data
Apr. 21, 2016 (DE) 10 2016 107 431.4

(51) Int. Cl. F24F 3/163; F24C 15/20; B01D 46/00; B08B 15/02; B01L 1/04

(52) U.S. Cl. CPC F24F 3/163; F24C 15/2035; B01D 46/008; B01D 46/0091; B01L 2300/0681; B01D 46/0032; B08B 15/023; B01L 1/04; B01D 2279/51; B01D 46/0005

(57) ABSTRACT

Fume extraction device, in particular laboratory fume extraction device, including a housing with an operating chamber that is accessible to an operator through an operating hole in the housing; the operating chamber is defined by a base, side walls and a cover; the operating hole and/or at least one fresh air supply hole in the area of the operating hole is/are provided for allowing fresh air to flow into the operating chamber, and at least one waste air hole in the area of the cover is provided for allowing waste air to escape. At least one filter holder for accommodating at least one filter element is placed upstream of the at least one waste air hole; the at least one filter holder is accessible through the operating hole such that the filter element is accessible and replaceable from the operating chamber.

The invention relates to a fume extraction device, in particular a laboratory fume extraction device, having a housing with an operating chamber that is accessible to an operator through an operating hole in the housing, said operating hole being located in an occupied area at the front of the operating chamber outside the fume extraction device, wherein the operating chamber is defined by a base, side walls and a cover, wherein the operating hole and/or at least one fresh air supply hole in the area of the operating hole, in particular close to the base, is/are provided for allowing fresh air to flow into the operating chamber and at least one waste air hole in the area of the cover is provided for allowing waste air to escape, such that the fresh air flows through the operating chamber in order to pick up particles from the operating chamber in the direction of the at least one waste air hole and flows as waste air via the at least one waste air hole out of the operating chamber.

A fume extraction device is also described in WO 2012/062 478 A1. The fume extraction device conditions the fresh air, flowing into the operating chamber, electrically, such that the particles, present in the operating chamber, and possibly also the surfaces of the side walls, base and so on, are electrically discharged or neutralised. The neutralised particles or the neutralised surfaces of the operating chamber prevent electrostatic adherence of the particles to the surfaces of the operating chamber, for which reason they can be properly and effectively picked up with the fresh air supply flowing through the operating hole or the at least one fresh air supply hole in the direction of the at least one waste air hole. However, in many cases the particles are hazardous. By way of example, medicinal products in particle form may find their way into the environment.

Therefore, the object of the present invention is to provide an improved fume extraction device.

To achieve this object, in a fume extraction device of the abovementioned type, it is provided that on the at least one waste air hole at least one filter holder for holding at least one filter element for filtering the waste air is arranged, wherein the at least one filter holder is accessible through the operating hole, such that the filter element is accessible and replaceable from the operating chamber.

The filter element is advantageously arranged on the filter holder in the direction of flow in front of the waste aft hole.

Thus, the fresh aft flows directly though the operating chamber from the at least one inflow opening or the operating hole, wherein it is able to pick up particles, dust and similar other impurities, to the waste aft hole or the waste aft holes. The at least one inflow opening is or expediently comprises an opening which discharges directly into the operating chamber.

It is a basic concept that a filter element substantially or completely filters out the particles from the waste aft, such that purified waste aft reaches the waste air hole. At the same time, the at least one filter element is easily accessible, namely through the operating hole and from the operating chamber. The operating hole that is in itself already present is, so to speak, also the maintenance opening for the at least one filter element, such that no further maintenance opening, by way of example on a side wall, is necessary. This is also particularly advantageous because, apart from such a maintenance opening sufficient space must generally be left to allow access to this. The operating hole, on the other hand, is provided at the front of the fume extraction device any way and must remain freely accessible to the operator.

A further aspect is that even during the filter change of the at least one filter element, waste aft is able to flow from the operating chamber in the direction of the waste aft hole and then through this, by way of example facilitated by a suitable waste air fan. Consequently, contamination of the operator changing the filter element with particles is largely avoidable, The particles, by way of example, drop from the filter element during filter change. While the operator is removing the at least one filter element from the filter holder, the waste aft is able to flow past the filter element into the waste air hole and in doing so carry with it any particles that have dropped from the filter element or other particles present in the operating chamber to the waste air hole.

It is preferably provided that the filter element, by way of example, comprises a filter fabric and/or a filter paper and/or a filter fleece as the filtration medium.

Expediently, the at least one filter element has a filter holder or a retaining body, in which the respective filtration medium is held.

The at least one filter element is, by way of example, a filter cartridge or comprises a filter cartridge.

It goes without saying that on the filter holder, by way of example two filter elements can be arranged in the direction of flow of the waste air alongside each other or one behind the other. By way of example, the retaining means further explained in the following are able to hold two or more filter elements arranged one behind the other in direction of flow of the waste air.

The at least one filter holder expediently comprises retaining means for retaining the at least one filter element. But the retaining means can also be provided on the filter element.

The retaining means preferably comprises an arrangement of hooks and/or catch means and/or clamping means.

Consequently, the filter element can, by way of example, be hooked by one or more hooks. Such a hook can be provided, by way of example, on the filter holder.

It is also possible for a catching projection to latch with a catching receptacle, wherein the catching projection is arranged on the filter element or on the filter holder and the associated catching receptacle on the respective other element of filter element and filter holder.

It is furthermore possible for the retaining means to comprise clamping means for clamping of the filter element to the filter holder, by way of example at least one clamping slope.

Combinations are perfectly possible, meaning that, by way of example, the clamping means interacts with the catch means or the form fitting retaining means. Consequently, the retaining means can also comprise a bar and a bar receptacle or similar.

The retaining means is expediently operable without a tool. It is particularly advantageous if a retaining means, by way of example a hook, bar or similar, has a handle section or handle suitable for manual gripping. By way of example, the hook described in the following can be dimensioned sufficiently large for it to be gripped and operated manually.

It is advantageous if for the at least one filter element at least one retaining element is provided, by way of example a hook or hook projection or also another form-fitting element or bar element, which is movable between a retaining position, in which the retaining element is engaged with the filter element, and a release position, in which the at least one filter element for removal from the filter holder is movable past the retaining element and/or in which the at least one filter element is movable relative to the filter holder. It is also possible for the retaining element to be provided on the filter element, by way of example constituting a retaining projection, which can be brought into and out of engagement with a matching contour on the at least one filter holder. Thus, by way of example, the retaining element can have an interlocking engagement with the filter holder in the retaining position, and be disengaged from the filter holder in the release position.

By way of example, a movable slide or a plurality of movable slides, pivoting latches or similar can be provided on the filter element, which can be brought into or out of engagement with a matching contour on the at least one retaining receptacle.

Preferably, the retaining means comprises at least one swivelling bar or sash lock, which can be swivelled in front of the at least one filter element to retain the same in the filter holder.

Advantageously, a hook or an arrangement of a plurality of hooks can be provided, the hook projection of these being adjustable, by way of example by rotating the hook about a swivel axis. An advantageous arrangement provides that at least two such retaining elements or hooks are provided, by way of example on opposing sides of the at least one filter element or the filter holder. The retaining elements or hooks can, by way of example, be swivelled about swivel axes away from the filter element into a release position, such that this can be moved past the hooks. In the retaining position, it is advantageous if the hooks dovetail with the at least one filter element. It may be sufficient for exactly two such hooks or retaining elements to be provided. It is also possible that only one hook or hook element or retaining element is provided, in particular in connection with the following measure.

A preferred embodiment of the invention provides that on the at least one filter holder at least one dovetail contour is provided, by way of example a U-shaped plug receptacle, a retaining projection or similar, with which the at least one filter element can be brought into engagement for securing to the filter holder. Thus it is, by way of example, possible for the filter element to be retained on the one side by the retaining projection or the other dovetail contour, while spaced apart from the dovetail contour at least one movable retaining element, by way of example the abovementioned hook or sash lock, is provided, The dovetail contour can, by way of example, be configured as a retaining web or similar or comprise a retaining web.

Obviously, it is also possible that, by way of example, a screw means or similar is provided, in order to fasten the at least one filter element to the filter holder in a fixed position. Thus, by way of example, a rotary bolt, a screw thread or similar, could be provided, which is manually operable by means of a handle or similar.

A preferred concept provides that the waste air is able to flow freely out of the operating chamber without a filter element upstream of the filter element to the at least one filter element. Consequently, no prefilter is then present, but the at least one filter element forms in the direction of flow of the fresh air from the fresh air supply hole or the operating hole to the waste air hole the first filter device. The waste air is, as it were, purified by the at least one filter element, before flowing into the waste air hole. The at least one filter element is thus expediently the filter element which is impinged or most impinged upon by the waste air or the particles contained therein. However, as explained, the at least one filter element can be easily exchanged in an ergonomic manner through the operating hole and via the operating chamber.

Expediently, the at least one filter element is arranged directly in the waste airflow from the operating chamber. The waste airflow from the operating chamber thus flows directly from the work area upwards in the direction of the filter element.

It is particularly advantageous if the at least one filter element or all filter elements of the fume extraction device has or have no filter upstream which filters an airflow flowing in the direction of the operating chamber.

It is also advantageous if in the direction of flow only the at least one filter element is upstream of the waste air hole or that this forms the only filter element. This does not preclude, by way of example, two filter elements being arranged alongside each other in the direction of flow with the waste airflow passing through them in parallel, so to speak. With this arrangement it is also possible for each of these two (or more) filter elements to be positioned upstream of the waste air hole without a further filter element upstream or downstream in the direction of flow of the waste air.

But it is also possible for a cover means or cover plate for the at least one filter element to be provided, in particular as described below.

The fume extraction device expediently comprises at least one plate-like cover means or cover plate to cover the at least one filter element towards the operating chamber.

The waste air flows through at least one flow opening from the operating chamber in the direction of the at least one filter element and thus also in the direction of the waste air hole. The flow opening is, by way of example, provided next to the cover means or on the cover means. In the direction of flow of the waste air towards the waste air hole, the cover means is arranged upstream of the filter element.

The at least one flow opening is preferably a through opening, having no filter element or similar.

By way of example, the at least one flow opening comprises through slots, holes or similar.

The at least one flow opening can, by way of example, comprise one or more slots, provided between a structure firmly attached to the housing of the fume extraction device and the cover means.

It goes without saying that a plurality of cover means or cover plates can be provided and/or that the cover means can be multi-part. Thus, by way of example, handling of a plurality of smaller cover means or a plurality of smaller segments, by way of example at least two segments, of a cover means may be simpler than handling a large-area cover means.

The cover means can, by way of example, be or comprise what is known as a baffle plate.

Advantageously, the cover means is arranged at an angle. A preferred concept provides that the cover means is, by way of example, arranged at an angle to the rear wall or cover or both of the operating chamber.

It can be provided that the cover means is permanently upstream of the filter holder. By way of example, a cover screen can be provided, which protrudes towards the filter holder and covers this at least partially. The at least one filter element can nevertheless be moved past the stationary cover means, such that it can be arranged on the filter holder or removed from the filter holder. Apart from a fixed cover means it is expedient to allow sufficient movement space for the filter element for attachment to the filter holder or removal from the filter holder.

However, a design is preferable in which the cover means is movable between an open position, in which it releases the at least one filter holder for removal or attachment of the at least one filter element, and a cover position, in which it at least partially covers the at least one filter element. By way of example, the cover means can be supported so that it can slide and/or swivel on the housing of the fume extraction device between the covered position and the open position. However, preference is for a concept in which the cover means is completely removable from the filter holder, such that the at least one filter element is freely accessible for a filter change accessible.

A preferred concept provides that the at least one fresh air supply hole comprises one or more of the fresh air supply holes described below:

Directly on the base of the operating chamber, in the area of the operating hole, a fresh air supply hole is expediently provided. Inflow openings laterally on the operating hole are also advantageous, through which, by way of example, laminar air or fresh air is able to flow into the operating chamber. Consequently, almost all around the operating hole a fresh air flow is always present, which prevents particles entering the environment from the operating chamber. On the contrary, any particles present in the environment are, as it were, conveyed into the operating chamber and to the filter element and ultimately to the waste air hole.

The at least one fresh air supply hole expediently comprises fresh air supply holes, which are provided on profile elements.

Advantageously, the fume extraction device comprises at least one fan arrangement to generate the fresh air flow or to pre-feed the fresh air. But the fan arrangement can also be provided or designed to generate a waste airflow or to pre-feed the waste air. The fan arrangement can also perform both, that is to say firstly feed the waste air, and secondly feed the fresh air. By way of example, the fan arrangement comprises at least one ventilator.

The fume extraction device can expediently be provided with an electric conditioning device for electrical conditioning, in particular neutralisation, of the fresh air and/or at least a surface defining the operating chamber. By way of example, the surface can be electrostatically discharged.

The fume extraction device can advantageously be provided with a conditioning device for electrical conditioning of the fresh air, in particular for neutralisation and/or for electrostatic discharging of the fresh air.

The conditioning device can, by way of example, be arranged directly on or in front of the at least one fresh air supply hole.

The conditioning device preferably comprises electrostatic charging means for electrostatic conditioning of the fresh air. The charging means is expediently arranged on or in a profile element, which for its part has at least one fresh air supply hole, through which the fresh air is able to flow into the operating chamber.

Thus, the at least one filter holder is advantageously located in an upper section of the operating chamber or a ceiling area of the operating chamber, but with its front covered towards the front side of the housing. An advantageous concept provides, for example, that the at least one filter holder is arranged behind a front wall. The front wall, just like the abovementioned side walls, defines, so to speak, an area of the housing, in which the at least one filter element is accommodated and which is open only downwards towards the operating chamber. It is also possible that in combination with this front wall or also on its own, a door, provided to close off the operating hole, is arranged in front of the at least one filter holder. Consequently, this door, by way of example a sliding door or a swing door, can cover the at least one filter element or the filter holder for the filter element frontally, i.e. towards the front side of the housing, even when the door completely or substantially releases the operating hole, when it adopts its open position. By way of example, the door is a sliding door, which in the open position is pushed upwards towards the cover, but which frontally still covers the at least one filter holder.

It is advantageously provided that the at least one filter holder can be gripped by a standing adult person who is, by way of example, between 1.60 m and 1.90 m tall, when the person is standing in front of the operating hole on a floor or on the base of the operating chamber.

As already indicated above, it is advantageous if the operating hole can be closed off by a closing device, in particular a door, a sliding door or a trap door, which is movable between an open position, in which the operating hole is accessible, and a closed position, in which the closing device closes off the operating hole. The closing device is, by way of example, designed as a slide, movable upwards to adopt the open position or downwards to adopt the closed position.

The following measure which advantageously provides that the at least one filter holder is arranged on the cover close to a rear wall of the operating chamber or a side wall forming the rear wall, may be ergonomically or fluidically advantageous. It is also possible for the filter holder to be arranged directly on the rear wall near to the cover. It is also possible for the filter holder to comprise both a section of the cover and the rear wall close the cover or to be arranged there. It can also be advantageous if the at least one filter holder is arranged on a rear top side of the operating chamber facing away from the operating hole. Consequently, the operator can, by way of example, grip at an angle, rearwards and upwards, away from the operating hole, to release the filter element from the filter holder or attach it to the filter holder. It is also advantageous if the fresh air, so to speak, flows from the operating hole, in particular from the base, at an angle, upwards and rearwards and flows through the at least one filter element to reach the waste air hole.

The abovementioned cover means can also be arranged in an advantageously ergonomic manner at an angle, rearwards and upwards (seen from a front side of the fume extraction device).

It is advantageously provided that the fume extraction device has at least two filter holders for respectively accommodating a filter element. Consequently, each filter holder can have a filter element releasably attached to it. One advantage, for example, is that the filter elements can be smaller. A further, or another, advantage can be that during exchange of one filter element the other filter element can remain in the other filter holder.

It is advantageous if each of the filter holders is associated with a waste air hole. So, at each waste air hole a filter holder for a filter element can be provided. Consequently, it is possible for the fume extraction device to have more than one waste air hole, namely by way of example at least two waste air holes. It is also possible for this plurality of air holes, by way of example two waste air holes, to discharge into a single waste air channel or to fluidically communicate with a single air channel. With the waste air channel—by way of example with an arrangement of a plurality of filter holders and filter elements the respective filter holder and/or the waste air hole associated with the filter element can be fluidically connected with a single waste air channel.

It goes without saying that further filter holders and/or waste air holes may be present. It is preferred if the filter holders or waste air holes or both are arranged in a row alongside each other, by way of example between the side walls, defining the operating chamber laterally next to the operating hole.

It is advantageous if a waste air hole, associated with a filter element, can be closed off, in particular during exchange of the filter element. It is preferably provided that the fume extraction device has at least one closing device for closing off the at least one waste air hole. The closing device can, by way of example, comprise a slide, a flap or similar.

The following disposal concept constitutes an advantageous design.

Preferably, on the at least one filter holder a holder for holding a receptacle, by way of example a sack, a box or similar, is provided, into which the filter or the filter element drops following release from the filter holder. Consequently, the filter element does not drop into the open air, so to speak, but dedicatedly into the receptacle. Together with the fume extraction device, the receptacle expediently forms a system.

It is preferred if the filter holder has a seal that surrounds the filter holder. It is also possible for the filter holder to alternatively or additionally have a contact surface, for example a circular contact surface, for a receptacle seal. The seal is preferably an O-ring. Seals can also be provided on the one hand on the filter holder and on the other on the receptacle as well. In any event, by means of the at least one seal it is possible for the receptacle to be arranged with a tight seal around the filter holder for accommodating the filter to be exchanged.

Disposal of the filter element is preferably designed as follows: a section of the receptacle accommodating the filter element, by way of example a bottom section of the abovementioned sack, can preferably be closed off, while the receptacle is still arranged on the filter holder. Consequently, the filter element removed from the filter holder can, so to speak, be securely enclosed in this bottom section or the section of the receptacle that in any event accommodates the filter element. By way of example, above the section accommodating the filter element, the receptacle is flexible and by means, by way of example, of a strap and/or work tool, in particular crimping pliers, can be constricted.

It is preferred if the holder for holding the receptacle is the same holder by which the cover means is also held. Thus, it is preferably provided that the holder for holding the receptacle is provided or designed for holding a cover means provided for covering the at least one filter element towards the operating chamber.

In the following, exemplary embodiments of the invention are explained by means of the drawing. This shows as follows:

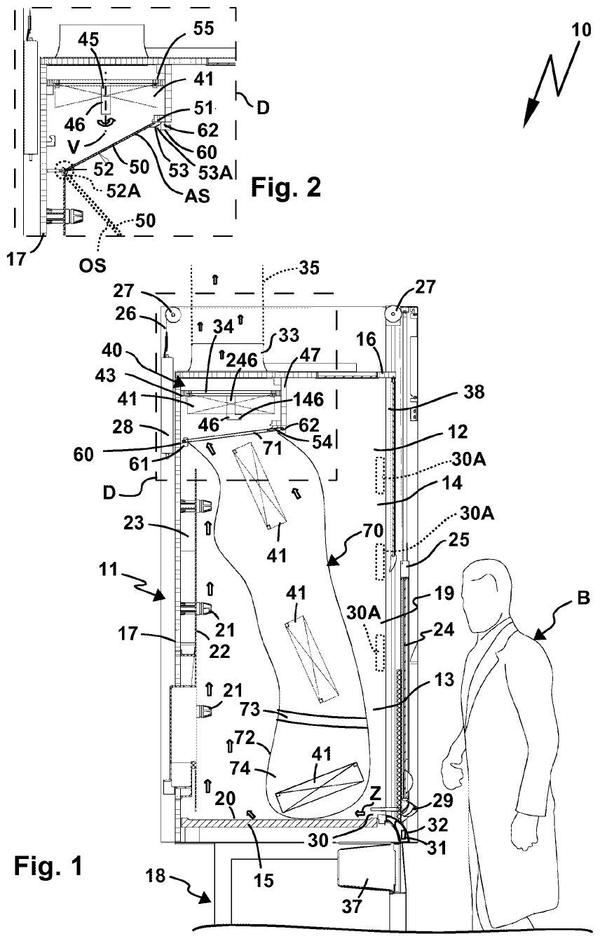

FIG. 1 a partial cutaway view of a fume extraction device; of which in

FIG. 2 a detail D from FIG. 1 is shown enlarged;

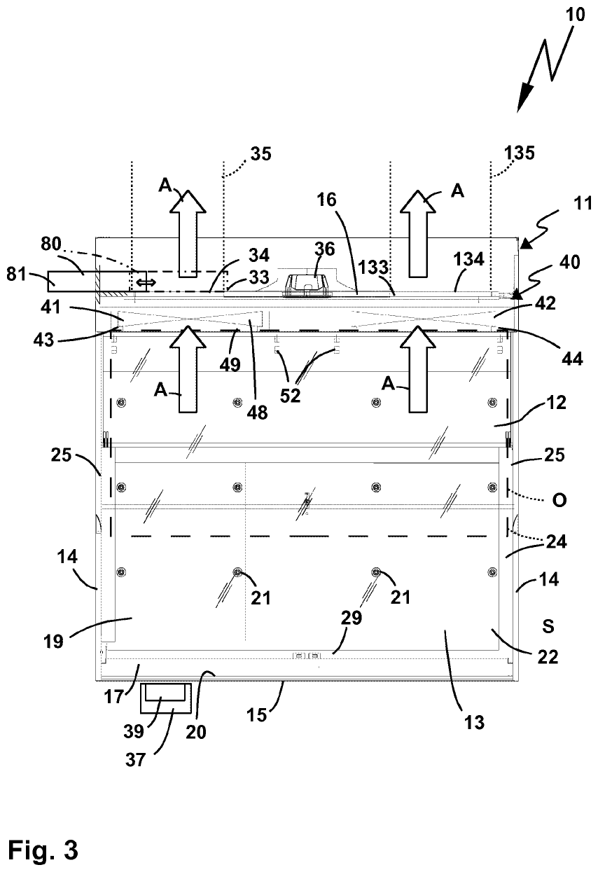

FIG. 3 a front view of an upper part of the fume extraction device according to the above figures;

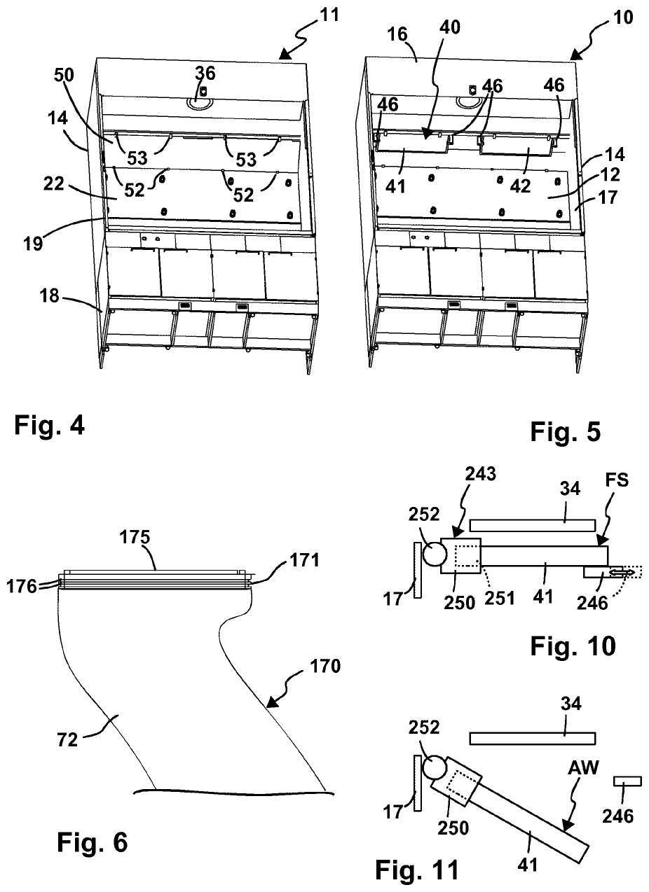

FIG. 4 a view from diagonally below into the fume extraction device according to the above figures, wherein a cover means still covers filter elements;

FIG. 5 the view according to FIG. 4, but with the cover means removed;

FIG. 6 an upper section of a collecting container with a seal;

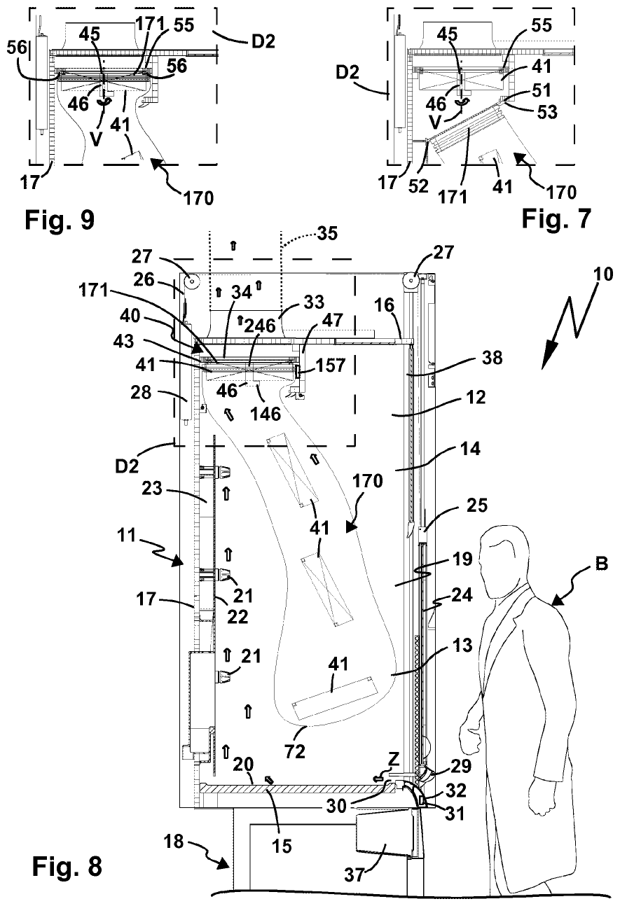

FIG. 7 a detail according to FIG. 2, but with the collecting container according to FIG. 6;

FIG. 8 the fume extraction device in the view according to FIG. 1, wherein the collecting container according to FIG. 6 is arranged in a position deviating from FIG. 7 for a filter change;

FIG. 9 a detail D2 from FIG. 8;

FIG. 10 a schematically represented further exemplary embodiment of a filter holder, on which a filter element is positioned in a working position or filter position; and

FIG. 11 the arrangement according to FIG. 10, wherein the filter element has been moved into an exchange position.

A fume extraction device 10 is designed as a laboratory fume extraction device, or a laboratory extractor for short. The fume extraction device 10 represented in the drawing is a fume extraction device for stationary use, but if, by way of example, rollers are mounted on the underside it could also be used as a mobile fume extraction device. The fume extraction device 10 comprises a housing 11, in the inside of which an operating chamber 12 is arranged. The operating chamber 12 defines a work area 13, which is available to an operator by way of example for research, processing or production of pure active substance, powdered active substances, fine particulates, in particular toxic fine particulates or also quite generally aerosols. The operating chamber 12 is defined laterally by side walls 14, at the bottom by a base 15, at the top by a cover 16 and at the rear by a rear wall 17. which is also a side wall per se. The side walls 14 and the rear wall 17 form a U-shaped configuration.

A substructure 18 or base, on which, as explained, by way of example rollers could be arranged, forms an underside of the fume extraction device 10. The substructure 18 can, by way of example, be a solid base or also have receiving spaces, in particular receiving spaces that can be closed off by flaps, drawers or similar.

The operating chamber 12 is frontally accessible through an operating hole 19, such that an operator B can, by way of example, with their arms or hands reach into the operating chamber 12. In this way, by way of example, on a top surface of the base 15, consequently a floor surface 20, objects can be positioned, e.g. containers, in which powdered active substances are contained, or similar.

Holders 21 are also arranged on the rear wall 17, to which objects can be attached. The holders 21 are, way of example, designed like tripods, protruding hooks or similar, wherein this is irrelevant here. The holders 21 penetrate a baffle wall 22 upstream of the rear wall 17, that substantially veneers the rear wall 17. Between the baffle wall 22 and the rear wall 17 a space 23 is provided, which is used to ventilate the operating chamber 12. The holders 21 thus protrude forwards in the direction of the operating chamber 12 from the rear wall 17 and penetrate the baffle wall 22, from which they similarly protrude. At the same time, the holders 21 serve as supports or holders for the baffle wall 22.

The operating hole 19 can be closed off by means of a door 24. Obviously, the door 24 could also be referred to as a window. In any event, the door 24 is a closing device for closing off the operating hole 19. The door 24 is designed as a sliding door and can be moved between an upper open position O substantially releasing the operating hole 19, and a lower closed position S, in which the door 24 closes off the operating hole 19, in at least a substantially air-tight way.

The door 24 has a plate-like design. The door 24 is movable on lateral guides 25 between the open position O and the closed position S, that is to say an upper and a lower position. In this connection it is noted that obviously a fume extraction device according to the invention can also have a trap door, a segmented sliding door or similar other doors or windows. A plurality of doors is also perfectly possible. Nevertheless, the operator is also effectively protected from the hazardous effects of the in particular powdered substances present inside the fume extraction device 10, that is to say in the operating chamber 12, by way of example pharmaceutical substances, toxic fine particulates or similar, even when the door 24 adopts its open position O or at least a part-open position. Opening of the door 24 is made easier by a counterweight arrangement, which comprises a tension element 26, which is connected at one end to the door 24, and at the other to a counterweight 28. The counterweight 28 counteracts the weight force of the door 24 and thus assists with opening the door 24 or moving it into the open position O. The tension element 26, by way of example a traction cable, runs across pulleys 27 in a manner known per se. The counterweight 28 runs up and down the rear wall 17.

The operator B can comfortably grip the door 24 by a handle 29 and move between the open position O and the closed position S.

In the vicinity of the base 15 there is a fresh air supply hole 30, through which fresh air Z can flow into the operating chamber 12. The fresh air supply hole 30 can comprises a plurality of part-openings or a plurality of fresh air supply holes 30 can be provided, by way of example as slots in an air routing body 31, in particular a corresponding air routing profile, extending along the floor area 20 transversally to the lower area of the operating hole 29. Consequently the fresh air Z is able, so to speak, to flow with a wide band from below into the operating chamber 12.

It is also advantageous if fresh air supply holes or inflow openings are provided in a manner not shown or in the manner in which they are shown as inflow openings 30A in the area of the side walls 14 on the operating hole 19, such that fresh air Z also flows laterally into the operating hole 19, in particular even when the closing device or door 24 adopts the closed position S. These fresh air supply holes are, by way of example, provided on or next to the guides 25 and/or on profiles, which provide the guides 25.

If the operator B opens the door 24, thus moves it into the open position O, fresh air Z in any case flows through the opening cross section of the operating hole 19 into the operating chamber 12.

The fresh air Z is pre-fed by a fan arrangement 37 to the at least one fresh air supply hole 30, which by way of example has a ventilator 39. The ventilator 39 sucks by way of example aft from the environment of the fume extraction device 10 and blows this into the air routing body 31, where it forms the fresh air Z or a fresh air flow.

It is advantageously provided that the fresh air Z is electrically conditioned by means of an electric or electrostatic conditioning device 32, that is to say, by way of example, ionised, neutralised, electrostatically discharged or electrostatically charged. The conditioning device 31 comprises, by way of example, suitable electrostatically or electrically chargeable surfaces or dischargeable surfaces, over which the fresh air flow Z passes, before flowing out from the fresh air supply holes 30.

The fresh air flow or the fresh air Z flows, so to speak, at an angle from the bottom through the operating chamber 12, from the front side of the fume extraction device 10 upwards to the cover 16, where waste air holes 34 and 134 are provided, through which the fresh air Z then flows out as waste air A. The waste air holes 34, 134 are, by way of example, provided on waste air connections 33, 133, to which waste air channels 35, 135 are connectable. The waste air channels 35, 135 are, by way of example, connected to a fan or discharge into the environment. Consequently, the operating chamber 12 is, so to speak, flushed or passed through by the fresh air Z, such that a safer non-hazardous work space or work area 13 is available for the operator B.

It goes without saying that the waste air connections 33, 133 could also be connected to a single waste air channel or that also a single waste air connection 33 or 133 is sufficient.

It is also advantageous for lighting for the operating chamber 12 to be provided on the cover 16, comprising by way of example one or more lighting elements 36. The lighting elements 36 scatter their light or the lighting element 36 scatters its light downwards in the direction of the base 15. The lighting element 36 is closer to a front wall 38 covering an upper section of the operating chamber 12 than the waste air connections 33, 133, which are closer to the rear wall 17.

However, the waste aft A does not leave the operating chamber 12 through the waste aft holes 34, 134 unfiltered, such that, by way of example, particles, in particular pharmaceutical particles, may reach the environment. To counter this problem, a filter arrangement 40 with filter elements 41, 42 is provided, which is held on filter holders 43, 44. The filter elements 41, 42 filter the waste air A, before it flows through the waste air holes 34, 134 associated with the filter elements 41, 42.

The filter elements 41, 42 are designed as filter cartridges, meaning that the filtration media 48 contained in the filter elements 41 are by way of example held on holding structures 49, in particular filter holders. The filtration media 48 comprise by way of example a filter fleece, filter papers or a similar other filtration medium suitable for retaining particles or other contamination in the waste air A.

The filter elements 41 are held by retaining means 45 on the filter holders 43, 44. The retaining means 45 are readily manually operable by the operator B. The retaining means 45 comprise, by way of example, hooks 46, able to swivel about a swivel axis V, such that the hook projections 146 of the hooks 46 reach under the filter elements 41, 42 (retaining position, FIG. 2) or are moved away from the filter elements 42, 41 (release position, FIG. 3), such that the filter elements 41, 42 can be removed from the filter holders 43, 44.

The hook projections 146 protrude, by way of example, in front of main bodies 246 of the hooks 46, which are arranged on a filter carrier 55, by way of example a plate, of the filter holders 43, 44. The main bodies 246 can, by way of example, be columnar. The main bodies 246 can for their part be supported such that they are rotatable about the swivel axis V on the filter carrier 55 or the hook projections 146 are supported such that they are rotatable relative to the main bodies 246 about the swivel axis V. In any event, the operator B can grip the hook projections 146 and from the front side rotate the filter elements 41, 42 away, such that the filter elements 41, 42 can be removed from the filter holders 43, 44. The hook projections 146 thus form handle sections or handle elements. Expediently, it is provided that on opposing longitudinal sides or transversal sides each filter element 41 or 42 is provided with a hook 46. Consequently, the hooks are able to hold a respective filter element 41 or 42 from opposing sides.

On the filter carrier 55 through openings upstream of the waste air holes 34, 134 are provided, which are covered by the filter elements 41, 42. The waste air A thus flows through the filter elements 41, 42, then the through openings and finally the waste air holes 34, 134, which are necessarily provided on the cover 16.

It can be seen that the filter elements 41, 42 can be comfortably changed from below, from the operating chamber 12. In doing so, the operator can, by way of example, remain in front of the fume extraction device 10 or possibly stand on the base 15, In any event, the retaining means 45 are comfortably accessible.

A front wall 47 expediently extends from the cover 16 downwards to the operating chamber 12. The cover 16, together with the upper sections of the side walls 14 and the rear wall 17 forms, by way of example, an air routing channel, in which the filter arrangement 40 is accommodated. The front wall 47 expediently forms a screen for the filter arrangement 40.

Consequently, the removal or mounting of a cover means 50, which is upstream of the filter elements 41, 42 in the direction of flow of the waste air A is very simple. The cover means 50 comprises, by way of example, a baffle plate or is plate-shaped. The cover means 50 is held by a holder 51. The holder 51 comprises, by way of example, one or more support projections 52 which, by way of example, are arranged on the rear wall 17 and protrude towards the operating chamber 12. The holder 51 also comprises, by way of example, movable bars or bar elements 53, arranged on the front wall 47, in particular on the free end area of this. The bar elements 53 form a locking system 53A.

However, the holder 51 can also comprise a bearing 52A for supporting the cover means 50 between an open position OS (shown by a dashed line in FIG. 2), provided for removing or attaching the filter elements 41, 42, and a covered position AS, by way of example for supporting the cover means 50 such that it can swivel. In the covered position AS the locking elements 53 or the locking system 53A can be used for locking the cover means 50.

The cover means 50 can be completely removed from the filter holder 43, 44, such that the filter elements 41, 42 are freely accessible for a filter change. This is possible with both the above embodiments. By way of example, the cover means 50 can be taken out of engagement with the support projections 52. A bearing seat for the bearing 52A can be designed to be open or openable. For example, a bearing seat is possible, which is open towards the top surface and/or laterally, such that a bearing pin, which engages in the bearing seat, can be removed upwards or laterally from the bearing seat.

The cover means 50 substantially covers the filter arrangement 40 towards the operating chamber 12. However, in particular in the area of the bar 53 flow through openings 54 are provided, by way of example slots, the longitudinal extension of which runs transversally between the side walls 14, through which the waste air A can flow out of the operating chamber 12 to the filter elements 41, 42. The flow through openings 54 can, by way of example, also form handle openings for gripping by the operator B, allowing the latter to seize the cover means 50 more easily and remove it from the holder 51 or attach it to the holder 51.

When the fume extraction device 10 is in continuous operation, thus while the waste air A is being aspirated through waste air holes 34, 134 or flows through the waste air holes 34, 134, the operator B can dispose of one of the filter elements 41, 42. This reduces the danger of the operator B coming into contact with particles or other hazardous goods.

While a filter element 41 or 42 is being changed, it may be advantageous if the respectively associated waste air hole 34, 134 can be closed off. By way of example, a closing device 80, by way of example a slide 81, can be provided, in order to close off a waste air hole 34 or 134. This is shown in the drawing for the example of waste air hole 34. The slide 81 can, by way of example, be moved into the closed position shown by a broken line when changing or prior to changing the filter element 41, such that it doses off the waste air hole 34. The waste air A then flows through the other filter element 42 and the other waste air hole 134, such that even if the filter element 41 is removed from the waste air hole 34, no unfiltered waste air A flows through the waste air hole 34.

A receptacle 70 ensures a very low contamination disposal principle. The receptacle 70 comprises, by way of example, a filter holder 71 for holding a sack 72. In the representation according to FIG. 1, the sack 72, which can also be referred to as a collection bag, hangs down from the filter holder 71 and is preferably flexible. Following release or opening of the retaining means 40, the filter element 41 or 42 can drop down into the sack 72, where it then comes to rest, way of example, on the bottom of the sack 72. The sack 72 is preferably long enough that its floor region can be supported on the base or floor area 20 of the operating chamber 12. Consequently, the filter element 41 does not actually penetrate the floor of the sack 72, when it drops down.

The filter holder 71 is removably attachable to a holder 60 below one or both filter holders 43, 44. By way of example, the holder 60 comprises hooks 61, 62 on the rear wall 17 and the front wall 47, on which the filter holder 71 can be suspended. The filter holder 71 then encloses the respective filter element 41 or 42 tightly or substantially tightly, such that this can be released from filter holder 41 or 44 and drop into the sack 72. It is advantageous here if the sack 72 is flexible, such that the operator B can operate the retaining means 45 by gripping the wall of the sack 72.

Once the respective filter element 41 or 42 has dropped into the sack 72 and in time come to rest in the lower area or section 74 of the sack 72, this section 74 can, so to speak, be isolated by, by way of example, slinging a strap 73 around the sack 72, such that the sack 72 is constricted and the filter element 42 or 41 is enclosed in a sealed manner in section 74.

A so to speak higher degree of freedom from contamination can be achieved with the collecting container 170 shown in FIG. 6. On the filter holder 171 of this, which holds a sack 72, by way of example circumferential seals 176 and/or an end-face seal are provided, which can be positioned to create a seal, by way of example on a contact surface 56 of the filter carrier 55. This is shown, by way of example in FIGS. 8 and 9. The filter holder 171 can be moved into the space between the front wall 47 and the rear wall 17, thus, so to speak, into the filter chamber of the filter arrangement 40, such that it rest on its end-face with the seal 175 on the contact surface 56. But a radial contact surface can advantageously also be provided, in particular for the circumferential seals 176, which in particular is provided by a seal 157 of the filter holder 43, 44. By way of example, the seal 157 is an elastic sealing surface on the front wall 47 (shown schematically in FIG. 8).

But the collecting container 170 can also be readily handled similarly to the receptacle 70 for a filter change, as shown in FIG. 7. By way of example, the filter holder 171 can also, so to speak, be suspended or hooked in the holder 51, wherein then by way of example the circumferential seals 176 take effect and, by way of example, are able to rest creating a seal on at least one sealing contour, by way of example on the front wall 47 (only indicated in the drawing and not shown explicitly).

From this exemplary embodiment according to FIG. 7 it is also clear that the holder 51, provided for holding the cover means 50, can at the same time form a holder for the collecting container 170. So, consequently, separate holders do not need to be provided for the cover means and the collecting container.

From the exemplary embodiment according to FIGS. 1 and 2 it is furthermore clear that the holders 51 and 60 can have common components, by way of example the moveable bar 53 and/or the hooks 62.

FIGS. 10 and 11 show a further exemplary embodiment. On a filter holder 243 which, by way of example, can be provided instead of the filter holders 43 and/or 44, a bearing 252 is provided, on which a holder 250 for the filter element 41 is arranged. The holder 250 has a plug receptacle 251, into which the filter element 41 or 42 can be plugged. The plug receptacle 251 accommodates the filter element 41, 42 preferably with a form-fit. By means of the bearing 252, the filter element 41, 42 can be moved between a filter position FS for, so to speak, covering the waste air hole 34 and in any case provided for filtering the waste aft A, and an exchange position AW remote from the waste aft hole 34. In the exchange position AW, the filter element 41, 42 can be plugged into the plug receptacle 251 or removed from this. This makes filter change easier.

In the fixing position FS, the filter element 41, 42 by means of a bar 246 which, by way of example is arranged on the housing 11 such that it cannot move and/or such that it can swivel, can be locked. In its unlocking position (shown by a solid line in FIG. 11 and by a broken line in FIG. 10) the bar 246 releases the filter element 41, 42 for movement, in particular swivelling, into the exchange position AW. In its locking position (shown in FIG. 10 by a solid line) the bar 246 locks the filter element 41 in the filter position FS.

It is worth mentioning that the bearing 252 can also be a sliding bearing and/or swivel-sliding bearing.

1. A fume extraction device, having a housing with an operating chamber that is accessible to an operator through an operating hole in the housing, said operating hole being located in an occupied area at the front of the operating chamber outside the fume extraction device, wherein the operating chamber is defined by a base, side walls and a cover, wherein the operating hole and/or at least one fresh air supply hole in the area of the operating hole, in particular close to the base, for allowing fresh air to flow into the operating chamber and at least one waste air hole in the area of the cover to allow waste air to escape, are provided, such that the fresh air flows through the operating chamber to pick up particles from the operating chamber in the direction of the at least one waste air hole and flows as waste air via the at least one waste air hole out of the operating chamber wherein, on the at least one waste air hole, at least one filter holder for accommodating at least one filter element provided for filtering the waste air is arranged, wherein the at least one filter holder is accessible through the operating hole, such that the filter element is accessible and replaceable from the operating chamber.

2. The fume extraction device according to claim 1, wherein the at least one filter holder and/or the at least one filter element has retaining means and/or catch means, for holding the at least one filter element on the filter holder.

3. The fume extraction device according to claim 2, wherein the retaining means comprises at least one a hook projection, which can be moved between a retaining position, in which the at least hook projection engages with a form-fit with the at least one filter element or the filter holder, and a release position, in which the at least one filter element is moveable relative to the filter holder and/or wherein the retaining means is operable without a tool and/or by means of handle section suitable for manual gripping.

4. The fume extraction device according to claim 1, wherein, on the at least one filter holder, at least one dovetail contour is provided, with which the at least one filter element can be brought into engagement for securing to the filter holder.

5. The fume extraction device according to claim 1, wherein the waste air is able to flow freely out of the operating chamber without a filter element upstream of the filter element to the at least one filter element.

6. The fume extraction device according to claim 1, further comprising a fan arrangement to pre-feed the fresh air and/or the waste air.

7. The fume extraction device according to claim 1, further comprising an electric conditioning device for electrical conditioning, neutralising and/or electrostatic discharging, of the fresh air and/or at least one surface defining the operating chamber.

8. The fume extraction device according to claim 1, further comprising at least one, plate-like, cover means for covering the at least one filter element towards the operating chamber.

9. The fume extraction device according to claim 8, wherein, on the cover means or next to the cover means, at least one flow opening for the waste air from the operating chamber in the direction of the at least one filter element is provided.

10. The fume extraction device according to claim 8, wherein the cover means runs at an angle to a rear wall or the cover of the operating chamber.

11. The fume extraction device according to claim 8, wherein the cover means can be moved between an open position, in which it releases the at least one filter holder for removal and arrangement of the at least one filter element, and a covered position, in which it at least partially covers the at least one filter element.

12. The fume extraction device according to claim 11, wherein the cover means is mounted on the housing of the fume extraction device such that it can move or swivel by means of a bearing between the covered position and the open position.

13. The fume extraction device according to claim 8, further comprising a locking system for locking and/or holding the cover means in the covered position.

14. The fume extraction device according to claim 8, wherein the cover means is removable from a holder provided for holding the cover means on the housing.

15. The fume extraction device according to claim 1, wherein the at least one fresh air supply hole comprises a fresh air supply hole directly on the base of the operating chamber in the area of the operating hole and/or lateral inflow openings on the operating hole.

16. The fume extraction device according claim 1, wherein the at least one filter holder is arranged behind a front wall and/or a door for closing off the operating hole, when it adopts its open position completely or substantially releasing the operating hole.

17. The fume extraction device according to claim 1, wherein the at least one filter holder is arranged on the cover close to a side wall forming a rear wall of the operating chamber or on the rear wall close to the cover and/or is arranged on a rear upper section of the operating chamber facing away from the operating hole.

18. The fume extraction device according to claim 1, further comprising at least two filter holders for respectively accommodating a filter element.

19. The fume extraction device according to claim 18, wherein on each filter holder, a waste air hole is provided and/or wherein the filter holders are fluidically connected with a single waste air channel.

20. The fume extraction device according to claim 1, further comprising at least one closing device for closing off the at least one waste air hole during an exchange of the filter element associated with the waste air hole.

21. The fume extraction device according to claim 1, wherein, on the at least one filter holder a holder for holding a receptacle is arranged, into which the filter element drops following release from the filter holder.

22. The fume extraction device according to claim 21, wherein the fume extraction device and the receptacle form a system.

23. The fume extraction device according to claim 21, wherein a section of the receptacle accommodating the filter element in the state of the receptacle when arranged on the filter holder is lockable, by means of a work tool and/or a fastening strap.

24. The fume extraction device according to claim 21, wherein the filter holder has a seal surrounding the filter holder and/or a contact surface for a seal of the receptacle, such that the receptacle can be arranged with a tight seal around the filter holder for accommodating the filter element to be exchanged.

25. The fume extraction device according to claim 1, wherein the filter holder has at least one plug receptacle for plugging in and/or attaching the at least one filter element.

26. The fume extraction device according to claim 1, wherein the filter holder has at least one bearing for the at least one filter element, by means of which the filter element can be moved between an exchange position provided for exchange and remote from the at least one waste air hole and a filter position of the at least one waste air hole provided for filtering the waste air.
